(19) United States
(12) Patent Application Publication
(10) Pub. No.: US 2009/0029019 A1
(43) Pub. Date: Jan. 29, 2009

(54) METHOD AND APPARATUS FOR PROCESSING MULTIPLE CONFECTIONERY ROPES

(75) Inventor: Bharat Jani, East Brunswick, NJ (US)

Correspondence Address: HOFFMANN & BARON, LLP, 6900 JERICHO TURNPIKE, SYOSSET, NY, 11791, US

(73) Assignee: CADBURY ADAMS USA LLC, Parsippany, NJ (US)

(21) Appl. No.: 12/180,292

(22) Filed: Jul. 25, 2008

Related U.S. Application Data
(60) Provisional application No. 60/952,256, filed on Jul. 27, 2007.

(51) Int. Cl. A23G 3/54; A21C 9/06; A21C 11/16

(52) U.S. Cl. 426/284; 99/450.6

(57) ABSTRACT

The present invention includes a method and apparatus for manufacturing center-filled confectionery products. The method of forming center-filled confectionery products includes the steps of simultaneously extruding a plurality of individual, continuous tubular ropes of a first confectionery product, filling each of the tubular ropes with a second confectionery product, simultaneously feeding the multiple filled ropes into a cutting apparatus, and cutting the multiple-filled ropes in the cutting apparatus. The invention also includes an apparatus for manufacturing center-filled confectionery products, including an extruder for extruding multiple individual tubular ropes, a filling station, and a cutting apparatus.

### CROSS-REFERENCE TO RELATED APPLICATIONS

The present application claims the benefit of U.S. Patent Application No. 60/952,256 filed Jul. 27, 2007, the contents of which are incorporated herein by reference.

### FIELD OF THE INVENTION

The present invention relates generally to a method and an apparatus for forming individual center-filled confectionery pieces from a continuous rope or strand. More particularly, the present invention relates to a method and apparatus for forming several such center-filled confectionery pieces simultaneously via extrusion and cutting of several individual ropes of confectionery.

### BACKGROUND OF THE INVENTION

Center-filled confectionery products are well known. These products typically have a solid or semi-solid exterior shell and a soft liquid or semi-liquid center. One well known example of such center-filled confectionery products are liquid-filled gum pieces.

One typical process for forming such center-filled confectionery products is to extrude a continuous rope or strand into a hollow-tubular configuration. The hollow rope is then filled with the soft or liquid confectionery product. Thereafter, the rope is traditionally processed in a longitudinally continuous fashion so as to size the rope and pass the rope between dies which continuously cut the rope into individual center-filled pieces. The process for forming such pieces and an apparatus for affecting the process is more fully shown and described in U.S. Pat. Nos. 6,838,098; 6,558,727; 6,472,001 and 6,284,291. Each of these patents is incorporated by reference herein for all purposes.

While these processes and similar processes serve adequately form center-filled confectionery products such as center-filled gum, the speed and efficiency of the process is limited due to the fact that the rope must be fed individually into the forming apparatus which typically processes the rope in a linear fashion. The rope, being a rubbery material, has a tendency to longitudinally contract after it is extruded, due to natural forces, this is comparable to a relaxation. The faster the product is extruded and reduced, the more likely it is to relax. With center filled products any longitudinal contraction after cutting may cause the center fill material to leak out of the product. Thus, there is a need to allow for an efficient process to produce gum, while avoiding the high shrinkage normally associated with preparation of such products.

It is desirable to provide a process and apparatus which more efficiently processes multiple ropes of individually extruded material simultaneously to increase the yield of the apparatus, while still allowing for such center-filled confectionery products to be sufficiently stable to prevent leakage. Further, it is desirable to provide a process and apparatus which more efficiently processes a rope of extruded material in such a fashion that reduces or eliminates the need to size and/or relax the rope prior to cutting.

### SUMMARY OF THE INVENTION

The present invention provides a method and apparatus which processes multiple ropes of material to increase yield. The method of the present invention involves extruding multiple continuous tubular ropes of a first confectionery product, filling the tubular ropes with a second confectionery product, and simultaneously feeding the multiple filled ropes into a cutting apparatus, and simultaneously cutting the multiple filled ropes into center-filled confectionery products.

In an aspect of the invention, an apparatus for manufacturing center-filled confectionery products is provided, the apparatus including an extruder, which simultaneously extrudes a plurality of individual continuous tubular ropes of a first confectionery product, a filling apparatus for filling each rope with a second confectionery product, and a cutting apparatus, for simultaneously cutting the plurality of individual continuous ropes into individual pieces.

In another aspect of the invention, a method for manufacturing center-filled confectionery products is provided, the method including the steps of extruding a continuous tubular rope of confectionery product, filling the continuous tubular rope with a second confectionery product, and feeding the filled tubular rope into a cutting apparatus, where the rope is cut into individual pieces.

### BRIEF DESCRIPTION OF THE DRAWINGS

FIG. 1 shows a schematic drawing of the center-filled consumable product forming apparatus as described herein.

FIG. 2 shows a close-up of one embodiment of the extruder, incorporating multiple extrusion nozzles.

FIG. 3 shows a chain cutting apparatus as described in one embodiment of the invention.

FIG. 4 shows a schematic arrangement of a plurality of chain cutters of FIG. 3.

### DETAILED DESCRIPTION OF THE PREFERRED EMBODIMENT

The present invention is directed to an apparatus for extruding continuous tubular ropes or strands of a first confectionery product. Embodiments described herein provide a multi-component composition which includes at least one center-fill region and a confectionery region. The individual confectionery piece may also include an outer coating or shell, which typically provides a crunchiness to the piece when initially chewed. The individual confectionery pieces may form a variety of shapes including pellet, tablet, ball, pillow, chunk, stick and slab, among others.

An extruder for extruding the continuous tubular ropes or strands of a first confectionery product is capable of extruding multiple individual tubular ropes of a center-filled confectionery product. The ropes may be of any shape or size desired, including circular, rectangular, or any other formation desired. In one embodiment, there are at least four simultaneously extruded tubular ropes; however any number of tubular ropes may be contemplated by the present invention. The tubular ropes are then simultaneously fed into a cutting apparatus for cutting individual pieces of center-filled confectionery products. This embodiment of the invention may incorporate several stages after extrusion, including a sizing step and a relaxation step.

In an alternate embodiment, the confectionery product may be extruded and fed directly into a cutting apparatus, such as a chain cutter. In this embodiment, the confectionery product may be extruded at substantially the correct size, and thus reducing or even eliminating the need for a rope sizing apparatus and/or a relaxation apparatus. Such extrusion may be performed by using a multiple extruder apparatus as described in U.S. Pat. No. 5,698,233, which is fully incorporated by reference herein.

### The Apparatus

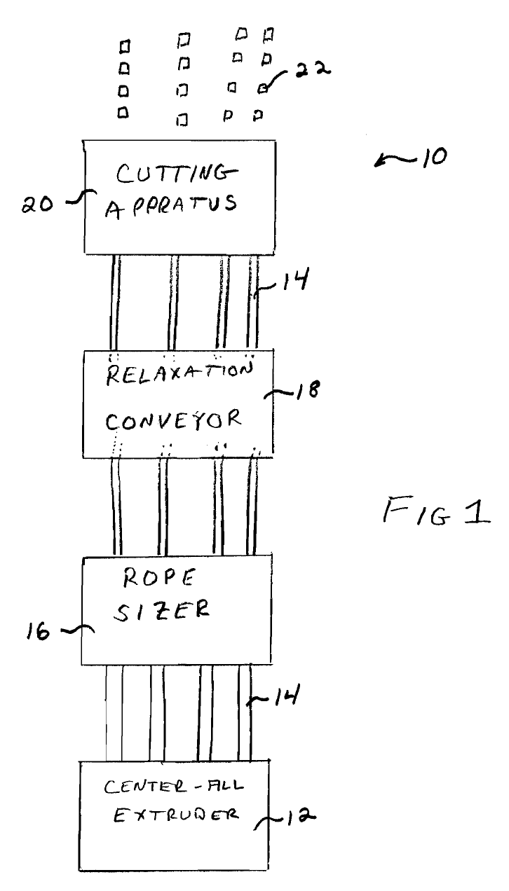

The apparatus 10 which may be used in conjunction with the present invention is schematically shown in FIG. 1. The apparatus 10 includes an extruder 12, which may extrude one or more center-filled ropes 14. The extruder 12 may include one or more injection nozzles for injecting liquid center-fill product into a hollow tubular rope(s) 14. The rope(s) 14 pass through a rope sizer 16, more fully described herein below, which reduces the size of the extruded rope(s) 14. The sized rope(s) 14 then pass to a relaxation conveyor 18, which will also be described in further detail hereinafter. The relaxation conveyor 18 allows the rope(s) 14 to relax. Thereafter, the rope(s) 14 are moved through a cutting apparatus 20, also more fully described below, which cuts the rope(s) 14 into individual pieces 22. A similar apparatus such as that disclosed in Applicant's co-pending U.S. provisional application (entitled “Method and Apparatus for Processing Confectionery Products”, Attorney Docket No. 1421-197P, filed Jul. 27, 2007), which is fully incorporated by reference herein, may be used.

### The Extruder

The present invention includes an extruder 12 which is capable of extruding a continuous tubular rope 14 of filled confectionery material. According to one aspect of the present invention, the extruder 12 is capable of continuously extruding a plurality of individual tubular ropes 14 of confectionery simultaneously. Preferably the tubular ropes 14 are extruded in a side-by-side fashion, but they may be extruded in a vertical manner, or in any other arrangement desired. According to the preferred embodiment of the invention, the extruder 12 extrudes four simultaneous tubular ropes 14, but it is contemplated that any number of simultaneous ropes can be extruded.

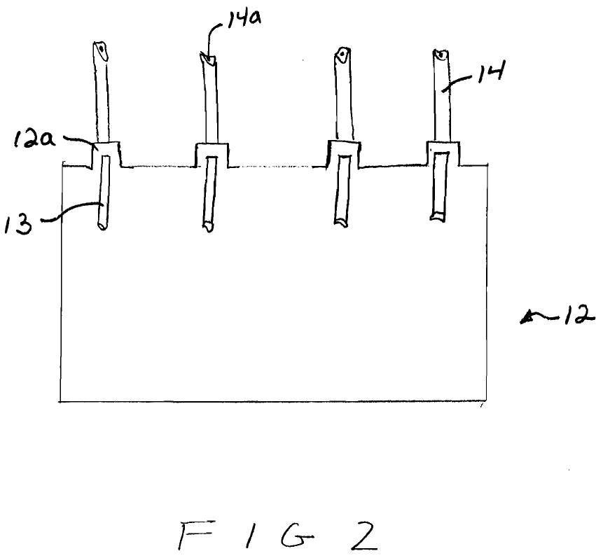

Referring to FIG. 2, several tubular ropes 14 of material may be extruded individually, through the use of several extruder dies 12a. Extruding multiple tubular ropes individually eliminates the need to separate the tubular ropes 14 at a later stage, such as would be required if the tubular ropes 14 are extruded as attached to each other.

In this embodiment, center-fill material 14a may be injected into the tubular ropes 14 during the extrusion process. The center-fill material 14a may be injected by center nozzles 13, located concentrically within the extruder nozzles 12a. While this is one technique that may fill the center-filled ropes 14, any suitable filling technique may be employed. The center fill composition 14a may be injected at any time desired, and preferably the center-fill composition 14a is injected directly into the tubular rope 14 at the time that it is being extruded, or soon thereafter.

In one embodiment of the invention, once extruded from the multiple extruder 12, the ropes 14 may be fed directly into the chain cutting apparatus 20, with no need for further sizing or relaxing of the rope product 14. Optionally, the product may be subjected to a time delay apparatus, such as a relaxation conveyor 18, prior to being fed into the cutting apparatus 20.

The extrusion may take place at any velocity desired. The velocity of the extrusion relates to the velocity of one or more of the other elements of the apparatus, including sizing, relaxation, and cutting velocities. Preferably, the extrusion feeds the rope product at a velocity of about 50 m/min to about 150 m/min, and more specifically at about 100 m/min.

### The Cutting Apparatus

Any conventional means to cut the confectionery product into individual pieces can be used with the present invention. Preferably the invention uses a chain cutter apparatus with multiple dies to cut a plurality of individual pieces from the continuous filled rope. Such chain cutting apparatuses include those described in Applicant's co-pending PCT patent application (entitled “Chain cutter for continuously forming center-filled gum pieces”, Attorney Docket No. 1421-182 PCT, filed Jun. 29, 2007), which is fully incorporated by reference herein.

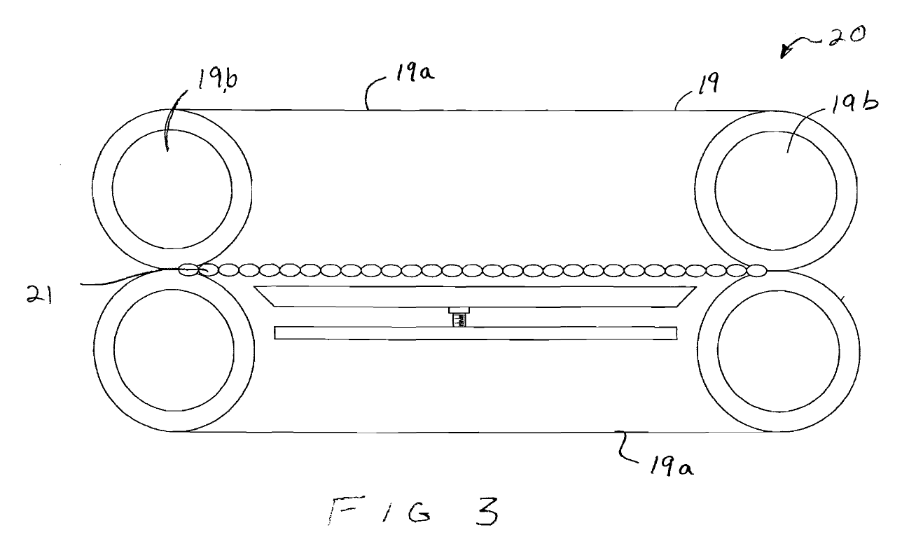

Referring now to FIG. 1, the cutting apparatus 20 may be provided after use of the optional relaxation conveyor 18; however the cutting apparatus 20 may be located after the optional rope sizer 16 or immediately after extrusion 12. According to an aspect of present invention, multiple continuous ropes 14 are fed into the cutting apparatus 20, wherein each rope 14 may be fed between the open die cavities 21 of multiple chain dies 19. One such chain die 19 arrangement is shown in FIG. 3. The die cavity portions 21 are then closed about the rope of product effectively forming and cutting the rope into a plurality of discrete pieces. The cutting apparatus 20 has a length as measured between the rollers 19b, which may be substantially long enough to allow the product to remain within the closed die cavities to be formed.

As the individual closed die cavity 21, which contains a piece of confectionery product within the cavity 21, traverses from one end of the cutter to the other, the first region of the product is effectively sealed. Such sealing is important with a center-filled gum product so as to prevent release of the liquid center from the formed piece.

The cutting apparatus may contain any number of individual die cavities 21. Preferably the cutting apparatus has about 10 to about 20 individual die cavities 21 per rope of confectionery.

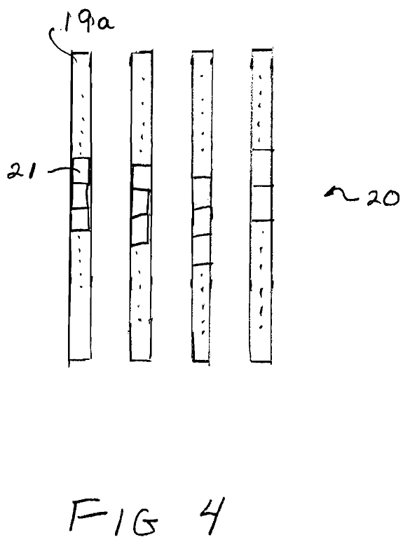

The cutting apparatus according to the invention should be sufficiently wide enough to allow multiple continuous tubular ropes 14 to be fed and cut simultaneously. Referring to FIG. 4, a preferred multiple rope chain cutting apparatus is shown schematically. The cutting apparatus 20 has a plurality of longitudinally aligned cutting die cavities 21 along its length. The tubular ropes 14 may be fed into the cutting apparatus 20 in a side-by-side formation, spaced sufficiently far apart so as to allow for individual cutting. The ropes 14 may alternatively be fed into the cutting apparatus 20 vertically, or any other manner which allows multiple cuts to be made. Preferably, the apparatus 20 may be sufficiently wide enough to allow at least four tubular ropes 14 to be cut, but any number of ropes 14 may be simultaneously cut pursuant to the present invention.

Each chain die 19 includes a pair of chains 19a supported between chain rollers 19b, which define therebetween the die cavities 21. The chain die is more fully described in the above-incorporated patent application.

### The Rope Sizer

The present invention may optionally incorporate the use of an apparatus to size the ropes after they are extruded, called a “rope sizer” 16. In traditional extrusion, the rope 14 is extruded at a size that is much thicker and larger than the end product. Thus, there may be a need for a proper sizing apparatus, which linearly extends the product, continuously stretching it out so that it is the right thickness and size.

Any rope sizing apparatus 16 may be used in the present invention, including that disclosed in Applicant's co-pending patent application (entitled “Method and Apparatus for Processing Confectionery Products”, Attorney Docket No. 1421-197P, filed Jul. 27, 2007), which has previously been incorporated by reference, may be used.

The preferred sizer 16 has a plurality of pairs of rollers, which have grooved openings to pull the rope product 14 through. As the gum goes through the rope sizer 16, the speed of the pairs of rollers increases, so the last pair of rollers moves at a speed that may be several times faster than the first pair of rollers. In addition, the grooved openings of the latter pair of rollers get smaller, which help to size the rope 14 properly.

One aspect of the invention manufactures multiple confectionery ropes, using multiple rope sizing apparatuses 16. The rope sizing pair of rollers may be side-by-side, may be vertically aligned, or may be arranged in any other formation that would allow the simultaneous sizing of multiple ropes of confectionery product. The rope sizer rollers may be connected to each other or they may be individually supported.

In one aspect of the invention, the rope sizing apparatus 16 may be located immediately after the tubular rope 14 has been extruded 12. The tubular ropes 14 of this aspect are extruded individually, and thus there may be no need for a separating apparatus between the sizing and the extrusion stages of the process. In other aspects of the invention, the rope sizing apparatus 16 may not be required, such as by using the multiple extruder apparatus 12 as described previously, and feeding the ropes 14 directly into the cutting apparatus 20.

### The Relaxation Conveyor

The method and apparatus of the present invention may optionally use a relaxation conveyor 18 to aid in the formation of the individual gum pieces 22. By “relaxation conveyor,” it is contemplated that any mechanism to allow the tubular confectionery 14 to “relax” and contract in size prior to cutting may be used. The relaxation conveyor 18 provides a time delay between extrusion 12 and/or sizing 16 and cutting 20, to allow the confectionery rope(s) 14 to get to a more stable form.

Any relaxation conveyors 18 may be used in the present invention, including those disclosed in Applicant's co-pending patent application (entitled “Method and Apparatus for Processing Confectionery Products”, Attorney Docket No. 1421-197P, filed Jul. 27, 2007), which has previously been incorporated by reference, may be used.

Preferably, the relaxation conveyor 18 incorporates the use of an optional swing arm, which feeds the confectionery rope(s) 14 onto the relaxation conveyor 18 in a non-linear path, such as a traditional wave pattern. In one aspect of the invention, the relaxation conveyor 18 may be located after the rope(s) 14 has been sized, such as through a rope sizing apparatus 16 as described previously, and before the rope(s) 14 is cut by the cutting apparatus 20. In other aspects of the invention, the relaxation conveyor 18 is not required, such as by using the multiple extruder apparatus as previously described.

When multiple ropes 14 are extruded, the use of a very wide relaxation conveyor 18 may be contemplated, but the use of multiple conveyors may also be used. For example, when extruding four continuous and simultaneous confectionery ropes 14, the ropes may be spread on the same relaxation conveyor 18, which may be wide enough to encompass all four ropes. In contrast, the use of four individual relaxation conveyors 18 may also be contemplated, each of which may be used to simultaneously transport one confectionery rope each. Further, the use of any other number of conveyors 18 is also contemplated, such as using two relaxation conveyors 18, each of which may be designed to transport two confectionery ropes 14.

In addition, the use of multiple swing arms is likewise contemplated. The confectionery ropes 14 may each be deposited on the relaxation conveyor 18 or conveyors via one swing arm simultaneously, or they may be deposited on the relaxation conveyor 18 or conveyors via multiple swing arms. As with the relaxation conveyor 18 itself, any number of swing arms may be used, to deposit one or more ropes 14 simultaneously. The use of a swing arm is an optional feature, and may be avoided if desired.

The confectionery products described herein may be manufactured by use of the extruder 12, rope sizer 16, relaxation table 18, and cutting apparatus 20, or they may be manufactured by use of any combination of these elements. For example, in one aspect of the invention, the products described herein may be extruded and then fed directly into the cutting apparatus 20. Further, the methods and apparatus described herein may be used to manufacture any number of confectionery ropes 14 simultaneously.

Optionally, an anti-sticking agent may be used in conjunction with the extruder 12, rope sizer 16, relaxation table 18, and cutting apparatus 20, to prevent the rope from adhering to the individual parts and getting stuck, which would decrease productivity. Generally, anti-sticking agents may be in the form of powders such as talc, calcium carbonate, or oils. For example, a fine mist of a food grade oil or an oil-based material may be sprayed on the rollers and material engaging surfaces of the rope sizer before or as the rope of gum material makes contact with the rollers. The oil temporarily reduces or eliminates the stickiness of the gum material and allows it to be sized without the need to cool the rollers with cooled air or nitrogen gas. In the alternative or in addition, it is also possible to apply the oil material directly on the rope of gum material. Suitable food grade oil or oil-based materials include, but are not limited to almond oil, apricot kernel oil, avocado oil, black cumin seed oil, borage seed oil, camellia oil, castor oil, cocoa oil, coconut oil, corn oil, cottonseed oil, evening primrose seed oil, grapeseed oil, hazelnut oil, hemp seed oil, jojoba oil, karanja seed oil, kukui nut oil, macadamia nut oil, meadowfoam seed oil, neem seed oil, olive oil, palm oil, peanut oil, pumpkin seed oil, rosehip seed oil, safflower oil, sea buckthorn oil, sesame seed oil, shea nut oil, soybean oil, sunflower oil, tamanu oil, vitamin E oil, and wheat germ oil. Synthetic oils may also be used. The anti-sticking agent may be applied to any individual part of the apparatus, or the rope 14 itself, to reduce sticking.

In an embodiment, the parts of the apparatus may be kept at a reduced temperature in order to prevent the confectionery material from sticking to the various parts described herein. For this purpose, cooled air or gas may be directed toward the rollers, the relaxation conveyor, the cutting apparatus, or any other part of the system in which the confectionery may potentially stick. The cooling air may flow directly at the surface of the parts to maintain it at a pre-determined temperature. In another embodiment, the parts themselves may be chilled, such as using a chilled extruder 12, a chilled rope sizer 16, a chilled relaxation conveyor 18 and/or a chilled cutting apparatus 20. Such cooling may be achieved through use of cooled fluid, such as water, liquid nitrogen, or other fluid. In an embodiment, the center fill material may be cooled upon exit from the filling apparatus. Using cooled center fill material has the effect of cooling the outer confectionery portion from the inside. The temperature of the parts is preferably maintained below −90° F., although the actual temperature may vary with the material and production rate. The individual parts and/or the confectionery itself may be cooled at any temperature from about −100° F. to about 50° F. In order to control costs of manufacture, the temperature should be just cold enough to support production, while inhibiting sticking of the confectionery.

What is claimed is:

1. A method of manufacturing center-filled confectionery products comprising the steps of:
extruding a plurality of individual, continuous tubular ropes of a first confectionery product;
filling each of said tubular ropes with a second confectionery product;
simultaneously feeding said multiple filled ropes into a cutting apparatus; and
cutting said multiple-filled ropes in said cutting apparatus.

2. A method of claim 1 further including the step of:
simultaneously sizing said multiple filled ropes.

3. A method of claim 2 further comprising:
providing a time delay for passage of said multiple ropes between said sizing step and said cutting step.

4. A method of claim 3, wherein said time delay is achieved through the use of at least one relaxation conveyor.

5. A method of claim 4, wherein said time delay is achieved through the use of one relaxation conveyor, which is wide enough to transport a plurality of said continuous tubular ropes simultaneously.

6. A method of claim 4, further comprising at least one swing arm to deposit said multiple continuous tubular ropes onto said at least one relaxation conveyor.

7. A method of claim 6, comprising one swing arm to deposit each individual continuous tubular rope onto said at least one relaxation conveyor.

8. A method of claim 1, wherein said filling step comprises the step of:
supplying a volume of said second confectionery product from a container; and
simultaneously injecting said second confectionery product from said container into said tubular ropes as they are extruded.

9. A method of claim 8, wherein said injecting step further comprises:
providing a plurality of injecting nozzles for injecting said second confectionery product into said tubular ropes.

10. A method of claim 2, wherein said sizing step further comprises:
providing a plurality of rollers for accommodating said filled ropes; and
simultaneously passing said tubular ropes between said rollers.

11. The method of claim 10, wherein the rollers closest to the entry point of the tubular ropes move slower than the rollers towards the exit point of the tubular ropes.

12. The method of claim 10, wherein the rollers closer to the entry point of the tubular ropes have a wider groove than the rollers towards the exit point of the tubular ropes.

13. A method of claim 1 wherein said cutting step further comprises:
providing a chain cutter, said chain cutter having a plurality of longitudinally aligned dies, wherein said chain cutter is wide enough to accommodate said plurality of multiple filled ropes in a side-by-side configuration.

14. The method of claim 1, wherein said cutting step comprises:
providing a chain cutter, said chain cutter having a plurality of longitudinally aligned dies, wherein said chain cutter is wide enough to accommodate said plurality of multiple filled ropes in a vertical configuration.

15. The method of claim 1, further comprising the step of applying an anti-sticking agent to at least one of the tubular rope after extrusion and the cutting apparatus.

16. The method of claim 1, wherein said plurality of individual, continuous tubular ropes of a first confectionery product are extruded simultaneously.

17. The method of claim 1, wherein said plurality of individual, continuous tubular ropes of a first confectionery product are extruded in an alternating pattern.

18. An apparatus for manufacturing center-filled confectionery products comprising:
an extruder, which simultaneously extrudes a plurality of individual, continuous tubular ropes of a first confectionery product;
a filling apparatus, which fills each of said individual, continuous tubular ropes with a second confectionery product; and
a cutting apparatus, which simultaneously cuts said plurality of individual, continuous ropes into individual pieces.

19. An apparatus of claim 18 further comprising a rope sizer.

20. An apparatus of claim 18 further comprising:
a time delay apparatus for passage of said multiple ropes between said sizing step and said cutting step.

21. An apparatus of claim 20, wherein said time delay apparatus comprises at least one relaxation conveyor.

22. An apparatus of claim 18, wherein said filling apparatus is located at a point substantially near the extrusion apparatus, such that each individual confectionery rope is filled at or near the time where it is extruded.

23. An apparatus of claim 22 wherein said filling apparatus comprises a plurality of injecting nozzles for simultaneously injecting said second confectionery product into said tubular ropes.

24. An apparatus of claim 19 wherein said rope sizer comprises a plurality of rollers for simultaneously accommodating said plurality of continuous ropes.

25. The apparatus of claim 24, wherein the rollers closest to the entry point of the tubular ropes move slower than the rollers towards the exit point of the tubular ropes.

26. The apparatus of claim 24, wherein the rollers closer to the entry point of the tubular ropes have a wider groove than the rollers towards the exit point of the tubular ropes.

27. A method of claim 18, wherein said cutting step further comprises:
providing a chain cutter, said chain cutter having a plurality of longitudinally aligned dies, wherein said chain cutter is wide enough to accommodate said plurality of multiple filled ropes in a side-by-side configuration.

28. The method of claim 18, wherein said cutting step comprises:
providing a chain cutter, said chain cutter having a plurality of longitudinally aligned dies, wherein said chain cutter is wide enough to accommodate said plurality of multiple filled ropes in a vertical configuration.

29. The method of claim 18, further comprising a means for applying an anti-sticking agent to at least one of the rope and the apparatus.

30. A method of manufacturing center-filled confectionery products comprising the steps of:
extruding a continuous tubular rope of confectionery product;
filling said continuous tubular rope with a second confectionery product; and
feeding said filled-tubular rope into a cutting apparatus
wherein said confectionery products are formed without the use of a rope sizing apparatus after extrusion.

31. The method of claim 30, further comprising the step of:
providing a time delay between the extrusion and feeding the rope into said cutting apparatus.

32. The method of claim 31, wherein said time delay is achieved through the use of a relaxation conveyor.

33. The method of claim 30, wherein said extrusion is achieved through the use of a multiple extruder.

34. The method of claim 30, further comprising a means for applying an anti-sticking agent to at least one of the tubular rope and the cutting apparatus.
